(19) United States
(12) Patent Application Publication
(10) Pub. No.: US 2017/0017346 A1
(43) Pub. Date: Jan. 19, 2017

(54) Input Sensor with Acceleration Correction

(71) Applicant: Apple Inc., Cupertino, CA (US)

(72) Inventors: Baboo V. Gowreesunker, Cupertino, CA (US); Alex Bijamov, Cupertino, CA (US); Vinay Chawda, Pasadena, TX (US)

(21) Appl. No.: 15/212,119

(22) Filed: Jul. 15, 2016

Related U.S. Application Data
(60) Provisional application No. 62/193,836, filed on Jul. 17, 2015.

(51) Int. Cl. G06F 3/041; G06F 3/044; G06F 3/0346

(52) U.S. Cl. CPC G06F 3/0418; G06F 3/0414; G06F 3/0346; G06F 3/044

(57) ABSTRACT

Systems and methods for detecting user input to an electronic device are disclosed. The electronic device can include an input sensor system that itself includes an input-sensitive structure that compresses or expands in response to user input. The input sensor system measures and electrical property of the input-sensitive structure for changes. The input sensor system is coupled to an accelerometer to receive acceleration data to modify the detected changes to the input-sensitive structure.

### CROSS-REFERENCE TO RELATED APPLICATIONS

This application is a nonprovisional patent application of U.S. Patent Application No. 62/193,836, filed Jul. 17, 2015 and titled “Input Sensor with Acceleration Correction,” the disclosure of which is hereby incorporated herein by reference in its entirety.

### FIELD

Embodiments described herein relate to electronic sensors and, more particularly, to electronic sensors configured to monitor a distance between separated components of an electronic device.

### BACKGROUND

An electronic device can include a sensor to receive user input. Some sensors obtain user input by measuring a distance between two separated components of the electronic device for variations from a baseline distance. A change in the measured distance corresponds to a change in the user's input. For example, a change in the distance between two parallel plates can correspond to a change in a magnitude of force applied by a user to one of the plates.

However, the distance between the separated components can also change as a result of external influences unrelated to user input. For example, an electronic device can experience an acceleration that induces a force which causes either or both of the separated components to move or deflect, thereby changing the distance therebetween. In these cases, the sensor's measurement of the distance between the separated components may result in an inaccurate or imprecise interpretation of user input.

### SUMMARY

Embodiments described herein may relate to, include, or take the form of an input sensor system including at least an input-sensitive structure, an electrical circuit coupled to the input-sensitive structure. The input-sensitive structure includes a first resilient element and a second resilient element (separated from the first resilient element). The electrical circuit is configured to measure a distance separating the first resilient element and the second resilient element. The input sensor system also includes an accelerometer and an input resolver coupled to the electrical circuit and to the accelerometer. The input resolver configured to receive the measured distance from the electrical circuit, receive acceleration data from the accelerometer, and modify the measured distance based on the acceleration data.

Additional embodiments described herein may relate to, include, or take the form of a method of detecting input including at least measuring a distance between two separated elements of an input-sensitive structure, receiving acceleration data from an accelerometer, modifying the measured distance based on the acceleration data, and comparing the modified distance to a baseline distance.

Further embodiments described herein may relate to, include, or take the form of an electronic device including at least a housing, an input surface coupled to the housing, an input sensor including at least a top plate and a bottom plate, an accelerometer, and an input resolver coupled to the input sensor and the accelerometer. The input resolver can be configured to measure a distance between the top plate and the bottom plate, receive acceleration data from the accelerometer, and modify the measured distance based on the acceleration data.

### BRIEF DESCRIPTION OF THE FIGURES

Reference will now be made to representative embodiments illustrated in the accompanying figures. It should be understood that the following descriptions are not intended to limit the embodiments to a limited set of preferred embodiments. To the contrary, it is intended that the following description covers alternatives, modifications, and equivalents as may be included within the spirit and scope of the described or depicted embodiments and as defined by the appended claims.

FIG. 1 depicts an electronic device incorporating an input sensor system including a force-sensitive structure.

FIG. 2A depicts a cross-section of a capacitive force-sensitive structure associated with an input sensor system.

FIG. 2B depicts the capacitive force-sensitive structure of FIG. 2A, specifically illustrating a deformation of the force-sensitive structure in response to a user force input.

FIG. 2C depicts the capacitive force-sensitive structure of FIG. 2A, specifically illustrating deformation of the force-sensitive structure in response to an acceleration.

FIG. 2D depicts the capacitive force-sensitive structure of FIG. 2A, specifically illustrating deformation of the force-sensitive structure as a result of physical damage.

FIG. 3 is a simplified system model diagram of an input sensor system in accordance with various embodiments described herein.

FIG. 4 depicts a method of determining whether to update calibration parameters of an input sensor system.

The use of the same or similar reference numerals in different figures indicates similar, related, or identical items.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein reference an electronic device incorporating an input sensor system to receive force input from a user. The input sensor system includes a force-sensitive structure defined by two resilient elements separated by a distance that changes with the magnitude of force applied to the structure. The force-sensitive structure is coupled to an input surface of the electronic device. A change in the distance between the resilient elements corresponds to a change in the force input applied to the input surface of the electronic device.

The input sensor system includes an electrical circuit to measure or infer the distance between the resilient elements (the “measured distance”). The measured distance is used in conjunction with known material properties of the force-sensitive structure to quantify the magnitude of the force (the “measured force”) applied to the input surface of the electronic device.

After obtaining the measured distance, the input sensor system resolves the measured distance into an acceleration portion and a user input portion. The acceleration portion of the measured distance is a change in the distance between the resilient elements that results from an acceleration of the force-sensitive structure unrelated to user input, such as sagging due to gravity or acceleration of the electronic device. The user input portion of the measured distance is a change in the distance between the resilient elements that results from the user's input force. In order to resolve the measured distance, the input sensor system obtains data from an accelerometer within the electronic device and uses said data to approximate the effects of the measured acceleration on the force-sensitive structure.

In the alternative, in some embodiments, the input sensor system resolves the measured force into an acceleration component and a user input component. The acceleration component of the measured force is a non-input force that results from an acceleration that induces a change in the distance between the resilient elements. The user input component of the measured force is the user's input force that induces a change in the distance between the resilient elements. As with embodiments described above, the input sensor system resolves the acceleration component of the measured force by approximating the effects of a measured acceleration on the force-sensitive structure

The input sensor system serves as a filter to reduce the effects of processing delays and/or communication latencies in and between the accelerometer and input sensor system. The filter is a second (or higher) order shift-invariant filter that inputs historical values for the acceleration portion and the user input portion of the measured distance to a dynamic motion model of the force-sensitive structure. The filter predicts the acceleration portion of the measured distance in real-time, thereby facilitating real-time determination of the user input portion of the measured distance and/or the user input component of the measured force.

The input sensor system periodically updates the coefficients that define the dynamic motion model to account for physical irregularities in the force-sensitive structure (e.g., damage or deformation, pre-existing or emergent manufacturing defects, and so on). The input sensor system obtains data from a touch sensor within the electronic device to determine affirmatively when the user is not applying force thereto. In response, the input sensor system updates the coefficients defining the dynamic motion model such that the filter outputs zero measured distance change and zero measured force.

In this manner, the electronic device receives an accurate and precise measurement of user force input, in real-time, from the input sensor system substantially independent of external non-input influences acting on the electronic device (e.g., acceleration, gravity, physical changes to the force-sensitive structure, and so on).

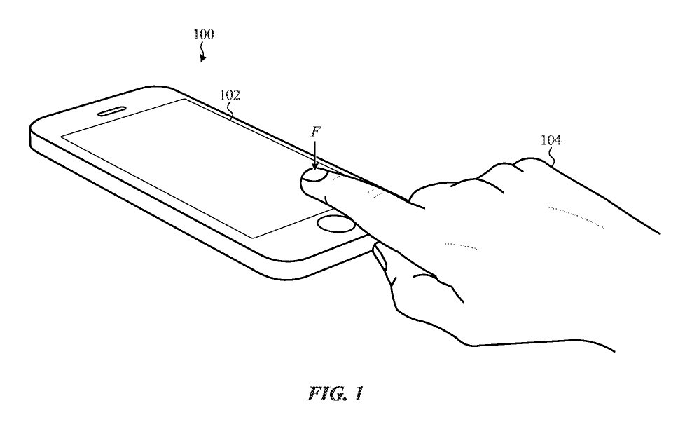

These and other embodiments are discussed below with reference to FIGS. 1-10. However, one skilled in the art will readily appreciate that the detailed description provided herein with respect to these figures is for explanation only and should not be construed as limiting.

FIG. 1 depicts an electronic device 100, such as a cellular phone, that incorporates an input sensor system to measure the magnitude of a force applied to an input surface 102 of the electronic device 100. The input sensor system includes a force-sensitive structure disposed within the housing of the electronic device 100 and coupled to the input surface 102. In this manner, a force F applied by a user 104 to the input surface 102 is transferred to the force-sensitive structure, which compresses in response. The input sensor system also incorporates an electrical circuit to measure an electrical property of the force-sensitive structure. The electrical property is used to quantify the magnitude of the force F applied to the input surface 102 by the user 104.

In one embodiment, the force-sensitive structure is defined by two electrically conductive plates that are separated by a compressible dielectric material. The electrical circuit monitors a capacitance across the force-sensitive structure for changes from a known baseline capacitance value. Changes in the measured capacitance correspond to changes in the distance separating the electrically conductive plates which, in turn, corresponds to changes in the magnitude of the force F applied to the input surface.

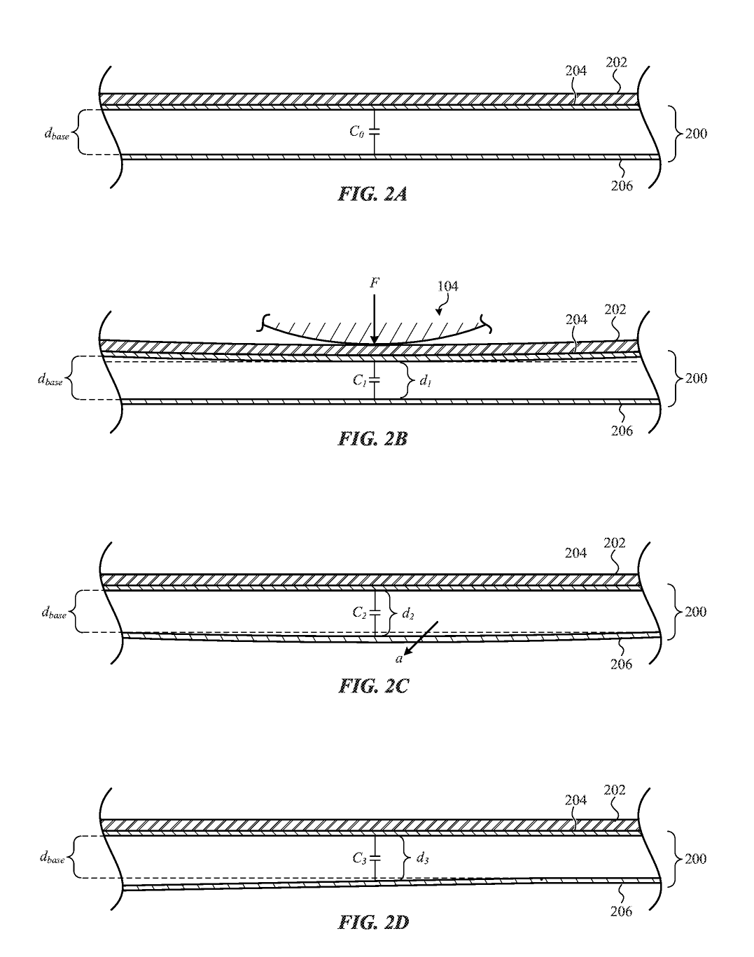

For example, FIG. 2A depicts a cross-section of a capacitive force-sensitive structure associated with an input sensor system as described herein. The force-sensitive structure 200 is disposed below an input surface 202 and includes a top plate 204 and a bottom plate 206 separated by a distance d₀. The top plate 204 of the force-sensitive structure 200 is mechanically coupled to the input surface 202; when a user applies a force to the input surface 202, the force at least partially transfers to the top plate 204, causing the top plate 204 to move, either locally or globally, toward the bottom plate 206. In this manner, the distance between the top plate 204 and the bottom plate 206 changes in response to a force received at the input surface 202.

The top plate 204 and the bottom plate 206 are coupled to an electrical circuit which measures a capacitance C₀ therebetween. The capacitance C₀ increases when the distance d₀ between the plates decreases. In other words, the capacitance C₀ is inversely proportional to the distance d₀, as represented by the simplified equation:

$${C}_{0} ∝ \frac{1}{{d}_{0}} \qquad Equation 1$$

The input sensor system uses the electrical circuit to measure the capacitance C₀ of the force-sensitive structure in order to obtain an approximation of the distance d₀ that separates the top plate 204 from the bottom plate 206. Thereafter, the input sensor system compares the distance d₀ to a known baseline distance d_{base} to determine whether the top plate 204 has moved toward the bottom plate 206. Alternatively, the input sensor system can compare the capacitance C₀ to a known baseline capacitance C_{base} to determine whether the top plate 204 has moved toward the bottom plate 206. When no forces are acting on the force-sensitive structure, the distance d₀ is equal to the known baseline distance d_{base} and the capacitance C₀ is equal to the known baseline capacitance C_{base}.

A change in the distance between the top plate 204 and the bottom plate 206 may be the result of user input. For example, a user 104 can apply a downward force F to the input surface 202, causing the input surface 202 and the top plate 204 to locally deform (e.g., bend) toward the bottom plate 206, such as depicted in FIG. 2B. As a result of the downward force F, and the corresponding reduction in distance between the plates, the capacitance C₁ between the top plate 204 and the bottom plate 206 becomes greater than the baseline capacitance C_{base} measured at the known baseline distance d_{base}.

A change in the distance between the top plate 204 and the bottom plate 206 may also be the result of external forces and/or accelerations unrelated to user input. For example, the bottom plate 206 may sag in response to the force of gravity. In another example, the bottom plate 206 and/or the top plate 204 may sag in response to an acceleration a, such as depicted in FIG. 2C. Sagging of the top plate 204 and/or the bottom plate 206 can cause a change in the distance separating the plates, thereby causing the capacitance C₂ between the top plate 204 and the bottom plate 206 to temporarily shift away from (e.g., become greater or less than) the baseline capacitance C_{base} measured at the known baseline distance d_{base}.

A change in the distance between the top plate 204 and the bottom plate 206 may also be the result of physical changes to the force-sensitive structure itself. For example, the force-sensitive structure 200 may be damaged during operation, causing either or both the top plate 204 and the bottom plate 206 to permanently deform, such as depicted in FIG. 2D. Deformation of the top plate 204 and/or the bottom plate 206 can cause a change in the distance separating the plates, thereby causing the capacitance C₃ between the top plate 204 and the bottom plate 206 to permanently shift away from (e.g., become greater or less than) the baseline capacitance C_{base} measured at the known baseline distance d_{base}.

As noted above, any change in the distance between the top plate 204 and the bottom plate 206, and the corresponding change in capacitance measured by the electrical circuit, may have occurred as a result of one or more influences other than user force input. Accordingly, in many embodiments, after obtaining the measured distance, the input sensor system resolves the measured distance into an acceleration portion and a user input portion.

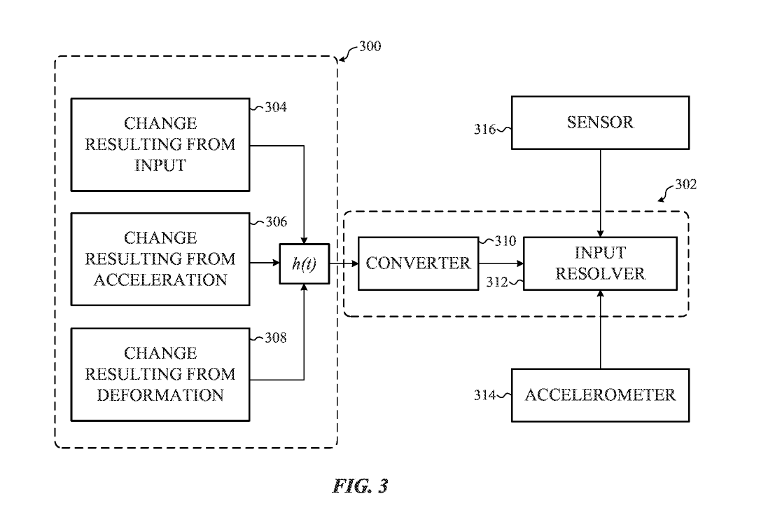

FIG. 3 is a simplified system model diagram of an input sensor system in accordance with various embodiments described herein. The simplified model of the input sensor system includes an input-sensitive structure 300 that is electrically coupled to a data processor 302. The input-sensitive structure 300 can be configured to measure force, as with embodiments described above, although this is not required.

The input-sensitive structure 300 is defined by two resilient elements separated by a distance that changes with an input desired to be measured such as force, touch, temperature, humidity, magnetism, electric field, pressure, sound, and so on. In some embodiments one or more intermediate layers interpose the two resilient elements.

The input-sensitive structure 300 outputs an electrical signal to the data processor 302. The electrical signal corresponds to and varies in real-time with the distance between the two resilient elements. For example, the electrical signal may be a voltage, current, pulse-width modulated, digital or other type of signal.

In other examples, the input-sensitive structure 300 is a passive electrical element (or circuit) which exhibits an electrical property that varies in real time with the distance between the two resilient elements. For example, the input-sensitive structure 300 can exhibit a variable resistance, inductance, capacitance, reactance, magnetic permeability, and so on.

The input-sensitive structure 300 can be mathematically modeled as a multiple-input, single-output linear time-invariant (“LTI”) system having an unknown transfer function h(t). The output of the LTI system is the electrical signal (or electrical property) corresponding to the real-time distance between the resilient elements. The inputs to the LTI system are the internal and external influences that, if present, can contribute to changes in the distance between the resilient elements. For example, the distance between the resilient elements can change as a function of a user input 304, as a function of a non-input acceleration 306, and/or as a function of a deformation 308 of the input-sensitive structure 300.

The input sensor system includes a converter 310 within the data processor 302 to receive the output from the input-sensitive structure 300 and to convert the received output into an approximation of the distance separating the resilient elements. For example, the converter 310 can be an analog-to-digital converter that receives an analog voltage signal and outputs a digital representation of the approximate distance separating the two resilient elements (the “raw distance data”).

In another example, the converter 310 can be a digital or analog circuit that measures an electrical property (e.g., capacitance, resistance, reactance, and so on) of the input-sensitive structure 300. The digital or analog circuit outputs a digital representation of the approximate distance (raw distance data) separating the two resilient elements.

The data processor 302 includes an input resolver 312 to receive raw distance data from the converter 310. After obtaining the raw distance data from the converter 310, the input resolver 312 resolves the raw distance data into a noise portion and a user input portion. The noise portion of the raw distance data corresponds to non-input changes in the distance between the resilient elements, such as sagging or bowing due to gravity or rapid movement of the input-sensitive structure 300.

To approximate the noise portion, the input resolver 312 obtains acceleration data from an accelerometer 314 positioned adjacent to the input-sensitive structure 300. Thus, any acceleration experienced by the input-sensitive structure 300 is measured by the accelerometer 314 and output to the input resolver 312.

The input resolver 312 thereafter uses the acceleration data to approximate the effects that the measured acceleration had on the input-sensitive structure 300 at the time the acceleration measurement was taken. For example, the input resolver 312 uses the acceleration data received at a particular time to determine whether the measured acceleration caused the input-sensitive structure 300 to increases the distance separating the resilient elements or whether the measured acceleration caused the input-sensitive structure 300 to decrease the distance separating the resilient elements at the time the acceleration measurement was taken.

The input resolver 312 employs a motion model of the input-sensitive structure 300 to simulate and/or approximate the effects of a measured acceleration to the input-sensitive structure 300 at a particular time t. After inputting the measured acceleration into the motion model, the input resolver 312 can determine an approximation of the amount of change in the distance separating the resilient elements that is due to the measured acceleration (e.g., the noise portion of the raw distance data).

In one embodiment, the input-sensitive structure 300 is modeled as a second-order differential equation, although high order models may be used (and may be more accurate) in other embodiments. For example, the distance y separating the resilient elements of the input-sensitive structure 300 can be modeled as a damped harmonic oscillator having a mass m, a damping coefficient c, and a stiffness k, as represented by the ordinary differential equation:

$$\ddot{y} + \frac{c}{2 m} \dot{y} + \frac{k}{m} y = a \qquad Equation 2$$

The input resolver 312 receives an acceleration measurement a from the accelerometer 314 at time t. Thereafter, the input resolver 312 solves the differential equation presented above to obtain a value for the distance separating the resilient elements at time t that is a result of the acceleration a. After solving the differential equation, the input resolver 312 obtains an approximation of the actual distance separating the resilient elements. By subtracting the actual distance separating the resilient elements from the raw distance data, the input resolver 312 obtains an approximation of the noise portion of the raw distance data. Thereafter, the input resolver 312 can subtract the noise portion from the raw distance data in order to obtain the user input portion.

In many embodiments, especially for embodiments in which the input resolver 312 is implemented as a digital processor, it is more computationally efficient to express the motion model as a difference equation (e.g., discrete time instead of continuous time). In these cases, the continuous-time motion model (expressed as an ordinary differential equation) is associated with an initial value, such as the baseline distance separating the resilient elements of the input-sensitive structure 300. Given the initial value, the ordinary differential equation can be solved using the Laplace transform thereof. For example, the ordinary differential equation presented in Equation 2 has a Laplace transform:

$${s}^{2} Y + \frac{c}{2 m} sY + \frac{k}{m} Y = A \qquad Equation 3$$

The equation can be rebalanced such that transforms related to distance and acceleration (e.g., L(y)=Y and L(a)=A) are separated to one side:

$$\frac{Y}{A} = \frac{1}{{s}^{2} + \frac{c}{2 m} s + \frac{k}{m}} \qquad Equation 4$$

Next, the equation can be transformed into a discrete-time transform via, in one example, the bilinear transform method:

$$\frac{Y}{A} = \frac{{α}_{0} + {α}_{1} {z}^{- 1} + {α}_{2} {z}^{- 2}}{1 + {β}_{1} {z}^{- 1} + {β}_{2} {z}^{- 2}} \qquad Equation 5$$

The coefficients α₀, α₁, α₂, β₁, and β₂ cooperate to define the motion model of the input-sensitive structure 300 and are related to the physical properties of the input-sensitive structure 300, such as the mass m, the damping coefficient c, and the stiffness k. Lastly, the discrete-time transform may be expressed as a constant coefficient difference equation sampled n times at time interval T:

yₙ=α₀·αₙ+α₁·αₙ₋₁+α₂·αₙ₋₂−β₁·yₙ₋₁−β₂·yₙ₋₂ Equation 6

The values of the coefficients α₀, α₁, α₂, β₁, and β₂ can be determined in a number of ways. In one example, the coefficients are determined or approximated experimentally. For example, the distance separating the resilient elements of the input-sensitive structure 300 is recorded simultaneously with acceleration data from the accelerometer 314. Thereafter, values for the coefficients α₀, α₁, α₂, β₁, and β₂ are selected so that the coefficients define a motion model that is the best fit of the acceleration and distance data. In some embodiments, the initial values for the coefficients are determined during manufacturing of the input-sensitive structure 300. In other examples, the initial values for the coefficients are determined by the input resolver 312.

Once the coefficients α₀, α₁, α₂, β₁, and β₂ are determined, the only inputs to the motion model are the two most-recent historical distance values yₙ₋₁ and yₙ₋₂, the two most-recent historical acceleration values αₙ₋₁ and αₙ₋₂, and the current acceleration value αₙ. In other words, for any given sample n, the only new input required is the measured acceleration from the accelerometer 314; all other necessary values are historical values that have been previously ascertained. In many cases, the historical values are stored within a memory accessible to the input resolver 312.

In this manner, the motion model of the input resolver 312 serves as a shift-invariant filter to reduce the effects of processing delays and/or communication latencies in and between the accelerometer 314 and input resolver 312. In other words, by using historical data, the motion model the input resolver 312 predicts the actual distance separating the two resilient elements of the input-sensitive structure with greater accuracy and precision than a simple correction model which only considers real-time acceleration data.

The input resolver 312 periodically updates the coefficients that define the motion model. Such a process is referred to herein as “adapting” the motion model.

For example, in some embodiments, the input resolver 312 is in communication with a sensor 316. The sensor 316 is configured to detect affirmatively whether an input should be detected by the input-sensitive structure 300. For one example, if the input-sensitive structure 300 is configured to detect force, the sensor 316 may be configured to detect a user touch. In this manner, the sensor 316 can affirmatively determine by the absence of a user touch that a force is not applied to the input-sensitive structure 300.

Upon determining that that no input should be detected by the input-sensitive structure 300, the input resolver 312 can adapt the coefficients that define the model in order to improve the accuracy and precision of the same.

The input resolver 312 can adapt the motion model in a number of ways. In one embodiment, the input resolver 312 can compare the raw distance data to the predicted distance data output from the motion model. The difference between these data is error, as shown in the following equation:

Errₙ=yₙ=y_{measured} Equation 7

Upon determining that an error of sufficient size is present (e.g., the input resolver 312 may not adapt the coefficients for small error), the input resolver 312 can iteratively change one or more of the coefficients α₀, α₁, α₂, β₁, and β₂, in an attempt to minimize said error. In another embodiment, the input resolver 312 performs a Gauss-Newton of minimization of the error function. In many cases, the coefficients α₀, α₁, α₂, β₁, and β₂ may be selected so that the motion model is stable. In other examples, other methods of determining values for the coefficients α₀, α₁, α₂, β₁, and β₂ are used.

In other embodiments, the input resolver 312 periodically adapts the motion model based on data output from the accelerometer. For example, if the accelerometer 314 determines that a high-magnitude acceleration is present, the input resolver 312 may adapt the motion model.

In still further embodiments, the input resolver 312 utilizes other algorithms, processes, or methods to determine when and/or if the motion model of the input sensor system should be updated.

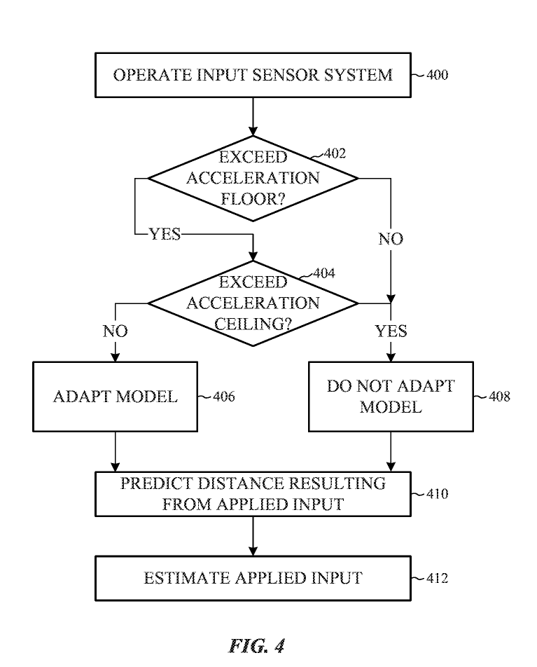

FIG. 4 depicts a method of determining whether to update calibration parameters of an input sensor system. The method begins at operation 400 in which an input sensor system operations. As noted with respect to other embodiments described herein, an input sensor system can operate by periodically measuring a distance that separates two resilient elements of a force sensitive structure. Additionally, the input sensor system is in communication with an accelerometer; the accelerometer provides acceleration data to a motion model of the force sensitive structure used by the input sensor system.

At operation 402, the input sensor system determines whether an amount of acceleration measured by the accelerometer exceeds a minimum threshold (the “acceleration floor”). Upon determining that the measured acceleration does not exceed the acceleration floor, the method continues to operation 408, at which the motion model is not adapted.

Alternatively, at operation 402, the input sensor system may determine that the measured acceleration does exceed the acceleration floor, continuing the method to operation 404. At operation 404, the input sensor system determines whether an amount of acceleration measured by the accelerometer exceeds a particular maximum threshold (the “acceleration ceiling”). Upon determining that the measured acceleration does not exceed the acceleration ceiling, the method continues to operation 406, at which the motion model is adapted. Alternatively, upon determining that the measured acceleration exceeds the threshold, the method continues to operation 408, at which the motion model is not adapted.

After either operation 406 or operation 408, the method continues to operation 410, in which the motion model is used to predict the distance separating the resilient elements as a result of the acceleration. Next, at operation 412, the applied input can be estimated and/or approximated based on the model-corrected distance.

In other embodiments, the method depicted in FIG. 4 can omit the determination at operation 404.

Although many embodiments described and depicted herein reference input sensor systems for portable electronic device, it should be appreciated that other implementations can take other form factors. Additionally, although many embodiments are described herein with reference to input sensor systems configured to sense force input, it should be appreciated that other input types can be used. Thus, the various embodiments described herein, as well as functionality, operation, components, and capabilities thereof may be combined with other elements as necessary, and so any physical, functional, or operational discussion of any element or feature is not intended to be limited solely to a particular embodiment to the exclusion of others.

For example, although the electronic device 100 is shown in FIG. 1 is a cellular telephone, it may be appreciated that other electronic devices are contemplated. For example, the electronic device 100 can be implemented as a peripheral input device, a desktop computing device, a handheld input device, a tablet computing device, a cellular phone, a wearable device, and so on.

Further, it may be appreciated that the electronic device 100 can include one or more components that interface or interoperate, either directly or indirectly, with the input sensor system, for simplicity of illustration are not depicted in FIG. 1. For example, the electronic device 100 may include a processor coupled to or in communication with a memory, a power supply, one or more sensors, one or more communication interfaces, and one or more input/output devices such as a display, a speaker, a rotary input device, a microphone, an on/off button, a mute button, a biometric sensor, a camera, a force and/or touch sensitive trackpad, and so on.

In some embodiments, the communication interfaces provide electronic communications between the electronic device 100 and an external communication network, device or platform. The communication interfaces can be implemented as wireless interfaces, Bluetooth interfaces, universal serial bus interfaces, Wi-Fi interfaces, TCP/IP interfaces, network communications interfaces, or any conventional communication interfaces.

The electronic device 100 may provide information related to externally connected or communicating devices and/or software executing on such devices, messages, video, operating commands, and so forth (and may receive any of the foregoing from an external device), in addition to communications. As noted above, for simplicity of illustration, the electronic device 100 is depicted in FIG. 1 without many of these elements, each of which may be included, partially, optionally, or entirely, within a housing.

In some embodiments, the housing 106 can be configured to, at least partially, surround a display. In many examples, the display may incorporate an input device configured to receive touch input, force input, and the like and/or may be configured to output information to a user. The display can be implemented with any suitable technology, including, but not limited to, a multi-touch or multi-force sensing touchscreen that uses liquid crystal display (LCD) technology, light-emitting diode (LED) technology, organic light-emitting display (OLED) technology, organic electroluminescence (OEL) technology, or another type of display technology.

The housing can form an outer surface or partial outer surface and protective case for the internal components of the electronic device 100. In the illustrated embodiment, the housing is formed in a substantially rectangular shape, although this configuration is not required. The housing can be formed of one or more components operably connected together, such as a front piece and a back piece or a top clamshell and a bottom clamshell. Alternatively, the housing can be formed of a single piece (e.g., uniform body or unibody).

Further, it may be appreciated that the input surface of the electronic device 100 can receive an input (e.g., force, touch, temperature, and so on) in a variety of ways apart from direct user input. For example, in addition to or instead of the finger of the user 104, the input surface can receive force input from a stylus. In another example, the input surface can receive a force input from more than one finger and/or more than one style.

In other embodiments, a processor within the electronic device 100 can perform, coordinate, or monitor one or more tasks associated with the operation of one or more input sensor systems incorporated therein. For example, in one embodiment an input sensor system can adapt an associated motion model upon receiving an instruction from the electronic device 100. In one example, the electronic device 100 can send an instruction to update the motion model upon determining that the user has placed the electronic device 100 on a flat surface such as a table. In another example, the electronic device 100 can send an instruction to update the motion model upon determining that the user is engaged in an athletic activity that may induce acceleration of the electronic device (e.g., running, jogging, removing the electronic device from a pocket, and so on).

In another example, the electronic device 100 can determine that the motion model should not be updated upon detecting that the device is experiencing strong axial rotation, as detected by a gyroscope. In another example, the electronic device 100 can determine that the motion model should not be updated if detected error associated with opposite sides of the display is signed oppositely.

Further, although many embodiments described herein reference a single input sensor system, it may be appreciated that in some embodiments more than one input sensor system can be coupled to the same input surface. For example, the electronic device of FIG. 1 can include an array of individual input sensor systems, organized as an array. The individual input sensor systems can operate separately or cooperatively. In one embodiment, a single input sensor system can be coupled to more than one input-sensitive structure.

Additionally, although many elements and/or components of embodiments described herein reference analog or digital circuitry, one or more processors, one or more analog-to-digital converters, and so on, it may be appreciated that such elements and/or components may be implemented in a variety of ways. For example, the data processor 302 of FIG. 3 can be implemented as an analog circuit, a digital circuit, an application-specific integrated circuit, a series of instructions and operations performed by a processor, or any combination thereof.

Moreover, although many embodiments described herein reference an input-sensitive structure with two resilient layers separated by a distance such that compression or expansion of the input-sensitive structure can change an electrical property of the input-sensitive structure, such geometry is not necessarily required of all embodiments. For example, in some embodiments, more than two resilient layers can be included. In other examples, the two layers need not necessarily be resilient. For example, two layers can be rigid and an intermediate layer can be configured to elastically deform. In some examples, the layers can be formed from a resilient or rigid material such as glass, plastic, or metal. An intermediate layer can be air gap, a dielectric material, or a deformable material.

One may appreciate that although many embodiments are disclosed above, that the operations and steps presented with respect to methods and techniques described herein are meant as exemplary and accordingly are not exhaustive. One may further appreciate that alternate step order or, fewer or additional steps may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

What is claimed is:

1. An input sensor system comprising:
an input-sensitive structure comprising:
a first resilient element; and
a second resilient element positioned below and separated from the first resilient element;
an electrical circuit in communication with the input-sensitive structure and configured to measure a distance separating the first resilient element and the second resilient element;
an accelerometer; and
an input resolver coupled to the electrical circuit and to the accelerometer, the input resolver configured to:
receive the measured distance from the electrical circuit;
receive acceleration data from the accelerometer; and
modify the measured distance based on the acceleration data.

2. The input sensor system of claim 1, wherein the input resolver comprises a motion model configured to predict the effects of an acceleration on the input-sensitive structure.

3. The input sensor system of claim 2, wherein the input resolver is coupled to a sensor.

4. The input sensor system of claim 3, wherein the sensor is touch sensor coupled to an input surface of an electronic device.

5. The input sensor system of claim 4, wherein the input resolver is configured to adapt the motion model upon receiving an indication from the sensor that no object is touching the input surface.

6. The input sensor system of claim 1, wherein the input-sensitive structure further comprises an intermediate element interposing the first resilient element and the second resilient element.

7. The input sensor system of claim 6, wherein the intermediate element is formed from a dielectric material.

8. The input sensor system of claim 1, wherein the electrical property is capacitance.

9. The input sensor system of claim 1, wherein the first resilient element is configured to couple to an input surface of an electronic device.

10. A method of detecting input comprising:
measuring a distance between two separated elements of an input-sensitive structure;
receiving acceleration data from an accelerometer;
modifying the measured distance based on the acceleration data; and
comparing the modified distance to a baseline distance.

11. The method of claim 10, wherein measuring the distance between two separated elements of an input-sensitive structure comprises measuring, with an electrical circuit, a capacitance between the two separated elements.

12. The method of claim 10, wherein modifying the measured distance based on the acceleration data comprises:
inputting the acceleration data into a motion model configured to simulate effects of an acceleration on the input-sensitive structure; and
modifying the measured distance based on an output from the motion model.

13. An electronic device comprising:
a housing;
an input surface coupled to the housing;
an input sensor comprising:
a top plate coupled to the input surface; and
a bottom plate separated from the top plate;
an accelerometer; and
an input resolver coupled to the input sensor and the accelerometer, the input resolver configured to:
measured a distance between the top plate and the bottom plate;
receive acceleration data from the accelerometer; and
modify the measured distance based on the acceleration data.

14. The electronic device of claim 13, wherein the electronic device is a cellular phone, a tablet computer, or a wearable electronic device.

15. The electronic device of claim 13, wherein the input sensor comprises an electrical circuit coupled to the top plate and the bottom plate.

16. The electronic device of claim 15, wherein the electrical circuit is configured to measure a capacitance between the top plate and the bottom plate.

17. The electronic device of claim 13, wherein the input resolver comprises a motion model configured to predict the effects of an acceleration on the top plate and the bottom plate.

18. The electronic device of claim 17, wherein the input resolver is configured to adapt the motion model upon receiving an indication from the electronic device that no object is touching the input surface.

19. The electronic device of claim 13, wherein the top plate and the bottom plate are formed from a material selected from the group comprising metal, glass, and plastic.

20. The electronic device of claim 13, further comprising a dielectric material interposed between the top plate and the bottom plate.
